(19) United States
(12) Patent Application Publication
(10) Pub. No.: US 2014/0211801 A1
(43) Pub. Date: Jul. 31, 2014

(54) MULTIPLE MEDIA ACCESS CONTROL (MAC) ADDRESS RESOLUTION VERTICAL TRAVEL

(71) Applicants: Solomon Trainin, Haifa (IL); Yuval Bachrach, Haifa (IL)

(72) Inventors: Solomon Trainin, Haifa (IL); Yuval Bachrach, Haifa (IL)

(21) Appl. No.: 13/997,203

(22) PCT Filed: Sep. 12, 2011
(86) PCT No.: PCT/US11/51188

§ 371 Date: Mar. 11, 2014

(51) Int. Cl. H04L 12/741

(52) U.S. Cl. CPC H04L 45/745
USPC 370/392

(57) ABSTRACT

One or more devices or stations include a globally unique media access control (MAC) address, and one or more local virtual MAC Addresses. The local virtual MAC addresses are generated by an external entity, such as server. The stations and the server may be connected through an access point.

### BACKGROUND

Computing devices or devices which may also be referred to as stations (STA), such as laptop computers, desktop computers, tablet computers, etc. may implement the Open Systems Interconnection or OSI model that defines communication systems into smaller parts called layers. A particular layer is the data link layer that includes the Media. Access Control or MAC sub-layer. The MAC sub-layer may determine access to media of a computing device at a particular time. In certain instances, the MAC sub-layer may refer to a structure with MAC addresses inside a device. The MAC sub-layer uses MAC protocols to ensure that signals sent from different devices or stations (STA) in a network across the same channel do not collide.

Typically, devices are assigned a unique MAC address, In certain implementations, a device includes a network interface card or NIC. The NIC may include the unique MAC address. The MAC sub-layer is used moving data packets to and from one NIC to another NIC across a shared channel.

Certain implementations may use different communication stacks using different protocols, in communicating with other devices such as access points, docking stations, etc. For example, a device may include different applications communicated to separate external devices. In other words, an application on the device may be communicated to an Internet access point, and a different application may be communicated to a docking station or display. In certain instances, the docking station may provide communication of a device to multiple devices, where each communication may need different MAC services. For example, communication with a mass storage device may need encryption of MAC level messages, and communication with a monitor or TV set may employ content protection and hence does not mandate MAC level encryption. In such implementations, different MAC addresses may be needed.

When implementing a network(s) that uses personal basic service sets or PBSSs, a device or station (STA) may need multiple MAC addresses to provide different services to the upper layers of the OSI model. If the different MAC addresses are not provided by the manufacturer, allocation of the different MAC addresses should be supported. As discussed above, it is typical that only one unique MAC address is provided to a device. in certain implementations, allocated MAC addresses may only be locally unique, because they are used in a local network. However, the addresses should be unique in the local area in order to avoid address interference between different PBSSs in a network.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a diagram of an example system architecture with a device implementing multiple media access control (MAC) addresses.

FIG. 2 is a diagram of an example system architecture implementing multiple stations (STA) that are assigned media access control (MAC) addresses by a MAC Address Generation and Verification Server.

FIG. 3 is a diagram of an example architecture of a device or station that implements multiple media access control (MAC) addresses.

FIG. 4 is a diagram of example data structures for media access control (MAC) addresses implemented for multiple MAC addresses for a device or station.

FIG. 5 is a diagram example data structures for media access control (MAC) address generation and verification.

FIG. 6 is an example flow chart for generating and verifying media access control (MAC) addresses for multiple devices or stations.

### DETAILED DESCRIPTION

Additional Unique media access control (MAC) addresses are provided to one or more devices or stations in a network if the device needs more than one MAC address. The unique MAC addresses may be generated and verified by a MAC address generation and verification server.

Overview

Described herein are architectures, platforms and methods that allow unique MAC addresses to be provided to one or more devices or stations in a local network, where the unique MAC addresses are local to the network. Devices or stations may keep their globally unique assigned MAC addresses.

A personal wireless area network (WPAN) is a network used for communication among computing devices (for example, personal devices such as telephones and personal digital assistants) close to one person. The reach of a WPAN may be a few meters. WPANs may be used for interpersonal communication among personal devices themselves, the devices participating in the WPAN may be connected via an uplink to a higher level network, for example the Internet.

In order to support a WPAN, multiple MAC addresses may be used. Although in theory, using the OSI model, WPAN (and WLAN) may implement a single MAC address. However, the use of a single MAC addresses may be problematic. For example, when a device may have different host interfaces that are connected to different sub-systems. For example, there may be a display that is connected via a high definition multimedia interface (HDMI) connecting to the graphic sub-system while data is connected via peripheral component interconnect express to the main CPU sub-system. A different type of constrain could be a specific very low latency PAN service that use short messages. In this case, adding long structure to support OSI based routing creates high inefficiency.

The millimeter-wave WPAN and/or mmWave network may allow very high data rates (e.g., over 2 Gigabit per second (Gbps)) applications such as high speed Internet access, streaming content download (e.g., video on demand, high-definition television (HDTV), home theater, etc.), real time streaming and wireless data bus for cable replacement.

In the following detailed description, numerous specific details are set forth in order to provide a thorough understanding of the invention. However, it will be understood by those of ordinary skill in the art that the present invention may be practiced without these specific details. In other instances, welt-known methods, procedures, components and circuits have not been described in detail so as not to obscure the present invention.

Sonic portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, or transmission devices. The terms “a” or “an”, as used herein, are defined as one, or more than one. The term plurality, as used herein, is defined as two, or more than two. The term another, as used herein, is defined as, at least a second or more. The terms including and/or having, as used herein, are defined as, but not limited to, comprising. The term coupled as used herein, is defined as operably connected in any desired form for example, mechanically, electronically, digitally, directly, by software, by hardware and the like.

The term personal basic service set (PBSS) as used herein is defined as a basic service set (BSS) which forms an ad hoc self-contained network, operates in the DBand, includes one PBSS control point (PCP), and in which access to a distribution system (DS) is not present but an intra-PBSS forwarding service is optionally present. The term PCP as used herein, is defined as a station or STA that operates as a control point of the mmWave network. The term access point (AP) as used herein, is defined as an entity that has STA functionality and provides access to the distribution services, via the wireless medium or WM for associated STAs. The term directional band (DBand) as used herein is defined as any frequency band wherein the Channel starting frequency is above 45 GHz. The term DBand STA as used herein is defined as a STA whose radio transmitter is operating on a channel that is within the DBand. The terms “traffic” and/or “traffic stream(s)” as used herein, are defined as a data flow and/or stream between wireless devices such as STAs. The term “session” as used herein is defined as state information kept or stored in a pair of stations that have an established a direct physical link (e.g., excludes forwarding); the state information may describe or define the session. The term “wireless device” as used herein includes, for example, a device capable of wireless communication, a communication device capable of wireless communication, a communication station capable of wireless communication, a portable or non-portable device capable of wireless communication, or the like. In some embodiments, a wireless device may be or may include a peripheral device that is integrated with a computer, or a peripheral device that is attached to a computer.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, WLAN stations, wireless personal network (WPAN), and the like.

Types of WPAN stations intended to be within the scope of the present invention include, although are not limited to, stations capable of operating as a multi-band stations, stations capable of operating as PCP, stations capable of operating as an AP, stations capable of operating as DBand stations, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

Some embodiments may be used in conjunction with various devices and systems, for example, a video device, an audio device, an audio-video (A/V) device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a display, a flat panel display, a Personal Media Player (PMP), a digital video camera (DVC), a digital audio player, a speaker, an audio receiver, an audio amplifier, a data source, a data sink, a Digital Still camera (DSC), a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless AP, a wired or wireless router, a wired or wireless modem, a wired or wireless network, a wireless area network, a Wireless Video Are Network (WVAN), a Local Area Network (LAN), a WLAN, a PAN, a WPAN, devices and/or networks operating in accordance with existing WirelessHD™ and/or Wireless-Gigabit-Alliance (WGA) specifications and/or future versions and/or derivatives thereof, devices and/or networks operating in accordance with existing IEEE 802.11 (IEEE 802.11-2007: Wireless LAN Medium Access Control (MAC) and Physical Layer (PHY) Specifications) standards and amendments, 802.11ad (“the IEEE 802.11 standards”), IEEE 802.16 standards, and/or future versions and/or derivatives thereof, units and/or devices which are part of the above networks, one way and/or two-way radio communication systems, cellular radio-telephone communication systems, Wireless-Display (WiDi) device, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple input Multiple Output (MIMO) transceiver or device, a Single input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, a Wireless Application Protocol (WAP) device, or the like.

Some embodiments may be used in conjunction with one or more types of wireless communication signals and/or systems, for example, Radio Frequency (RE), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS. Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Other embodiments may be used in various other devices, systems and/or networks.

Some embodiments may be used in conjunction with suitable limited-range or short-range wireless communication networks, for example, “piconets”, e.g., a wireless area network, a WVAN, a WPAN, and the like.

Example System Environment

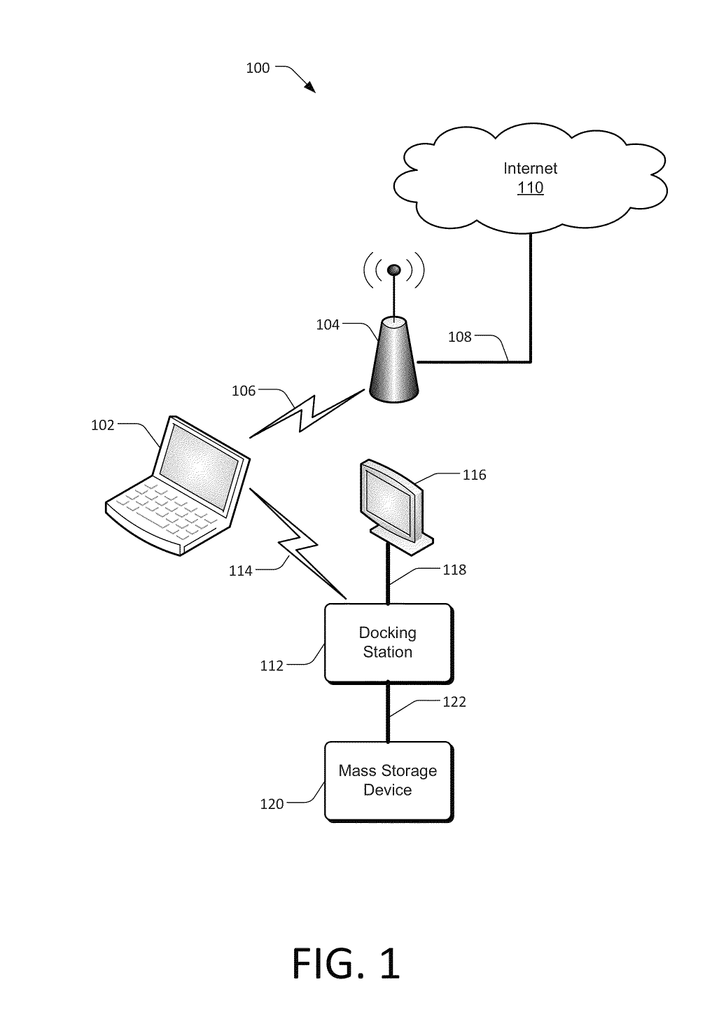

FIG. 1 illustrates a system-level overview of an exemplary system environment 100 for communicating between a wireless device or device 102 each one device may be identified by one or more MAC addresses. Device 102 may be referred to as STA in network or system environment 100, one or more device(s) 102 may be considered a STA. Device 102 includes various devices, such as laptop computers, tablet computers, smart phones, etc. Furthermore, it is to be understood that device 102 may include other devices.

Device 102 is identified by one or more MAC addresses, including a unique globally assigned MAC address. The MAC addresses are used to communicate with various other devices and/or access points. In this example, device 102 communicates with an Internet access point or AP 104 through a wireless connection 106. Traffic or traffic steams are sent through wireless connection 106. In certain implementations, the wireless connection 106 may be implemented using WiGig or IEEE 802.11ad specification, and operate over the 60 GHz frequency spectrum. Device 102 may be a DBand STA operating in the DBand. In addition, the wireless connection 106 may be a directed or beam formed link to the AP 104. Furthermore, device 102 may be in session with AP 104.

When communicating with AP 104, device 102 includes a unique MAC address in frames sent to the AP 104, where the unique MAC address identifies the frames as sent by the device 102. This unique MAC address may be a global MAC address that has been pre-assigned to the device 104. For example, device 102 may include a NIC that is identified by the global MAC address. For example, when communicating with the Internet, a global MAC address is preferable. In this example, the AP 104 is connected via a wired/wireless (or combination) connection 108 to the Internet 110.

In this example, device 102 further communicates with a docking station 112. In general the docking station 112 may connect many devices such as a display, a mass storage and others to the device 102 (i.e., mobile device such as notebook or cellular phone) via a wireless link. A different unique MAC address or MAC addresses are is used to communicate with the docking station 112. In other words, the MAC address used to communicate to AP 104 is different than the MAC addresses used to communicate to the docking station 112. Device 102 may communicate with the docking station 112 through a wireless connection 114. In certain implementations, the wireless connection 106 may be implemented using WiGig or IEEE 802.11ad specification, and operate over the 60 GHz frequency spectrum. In addition, the wireless connection 114 may be a directed or beam formed link to the docking station 112. A display 116 may be connected to the docking station 112 through wired connection 118, such as a high definition multimedia interface (HDMI) or display port connection. Furthermore a mass storage device 120 may have wired connection 122, such as universal serial bus or serial advance technology attachment.

In particular, the different unique MAC addresses of device 102 may be used to provide different services, or support different applications resident on device 102. Different applications may be supported by different communication layers on the OSI model. For example, an audio/video application in device 102 may employ one MAC address in the STA 102 to deliver audio/video traffic to the display via the docking STA 112, and a file transfer application in device 102 may employ a different MAC address in the STA 102 to deliver data to/from mass storage via the docking station 112. In certain implementations, the docking STA may also use different MAC addresses per different application/services.

Example System with MAC Address Generation and Verification Server

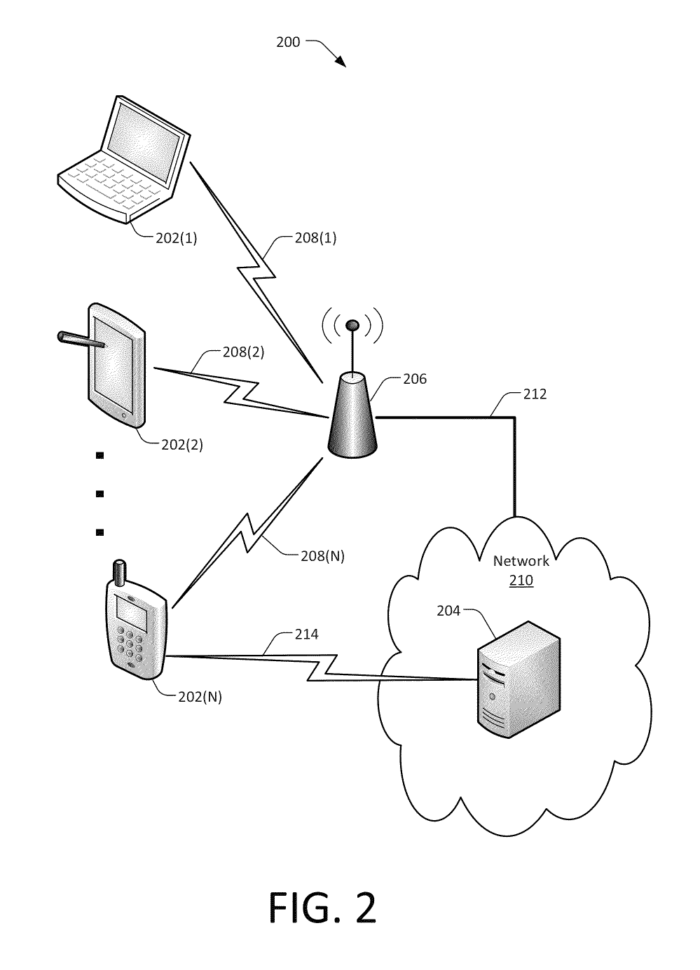

FIG. 2 illustrates a system-level overview of an exemplary system environment 200 implementing multiple stations or STAs 202 that are assigned MAC addresses by a separate MAC Address Generation and Verification Server(s) or MAGV server 204. The STAB 202(1)-202(N) may be devices such as device 102 described above, and may include various devices such as laptop computers, tablet computers, smart phones, etc. It is to be understood that other devices, as described above, may also be included.

The MAGV server 204 may be a standalone device or reside in a PCP or AP station. In certain implementations, the MAGV server 204 may be part of another device defined as a “Group Owner”, where communication between the MAGV server 204 and the STAs 202 may be through various communication bands, including the mmWave band. The ACV 204 may be supported at complex controlled environment such as enterprise, as well as at ad-hoc user environment in which proximity is guaranteed. At complex environments, MAGV 204 may not necessarily be directly connected to a device via the same media. As an example, the mmWave signal of a specific device may not be adequate for MAGV. Therefore, service may be tunneled. At the ad-hoc environment, MAGV 204 functionality is likely to be provided by the same device that provides the PCP function.

STAs 202 may communicate through an AP, or personal basic service set control point (PCP) 206, In certain implementations, the MAGV server 204 may be included as part of PCP 206. In such implementations, the MAGV server 204 may communicate over the mmWave band, such as a mmWave network discussed above, In specific, the PCP 206 communicates with the STAs 202 over the mmWave band. In certain implementations communication may be over a mmWave or WiGig radio band, implementing a 60 GHz frequency, using directed or beam formed links. Such communication links are represented by communication links 208(1) to 208(N).

Certain implementations, where the MAGV server 204 is a standalone device, provide for a “Group Owner”, the PCP 206, another AP, or other device to act as a “proxy” for the MAGV server 204. In other words, device 202(2) that needs service of allocation of multiple addresses connects to the MAGV server 204 through the proxy 206 using the connections 208(2) and 212. In the exemplary embodiment of the invention the PCP 206 is served as a proxy. In certain implementations, MAGV server 204 may be connected to multiple APs or PCPs to cover overlapping basic service sets (OBSS).

The MAGV server 204 may be part of a separate network 210, connected to PCP 206 through wired/wireless connection 212. The network 210 can include the Internet and cloud-based networks/services. In other implementations, server 204 is part of a local network, and in specific included as part of system 200. In certain implementations, a direct link, such as a beam formed link, may be establish with the MAGV server 204 and one or more of the STAs 202. Such a direct link is shown by example as link 214.

MAGV server 204 may be discovered by the STAs 202 through various methods, including known Level 2 (L2) service discovery techniques. Other methods of discovering the MAGV server 204, include the PCP 206 advertising or broadcasting services of the MAGV server 204 to the STAs 202. In certain implementations, the PCP 206 is used as a proxy that redirects the STAs 202(1) to the MAGV server 204. In other cases the STAs 202(N) and MAGV server 204 may communicate directly via direct link 214.

The MAGV server 204 specifically provides unique MAC addresses to the STAs 202. The unique MAC addresses may be local to the network of the STAs 202, where such a network includes system 200. Furthermore, each station may have more than one local, also known as “virtual”, MAC address. Each local/virtual MAC address is generated or verified by the MAGV server 204. Since the MAC addresses are generated and verified at a central provider, i.e., MAGV server 204, each MAC address is unique. Therefore, in a local network, such as system 200, contention regarding same MAC addresses at different STAs 202 is avoided.

Example Device/Station

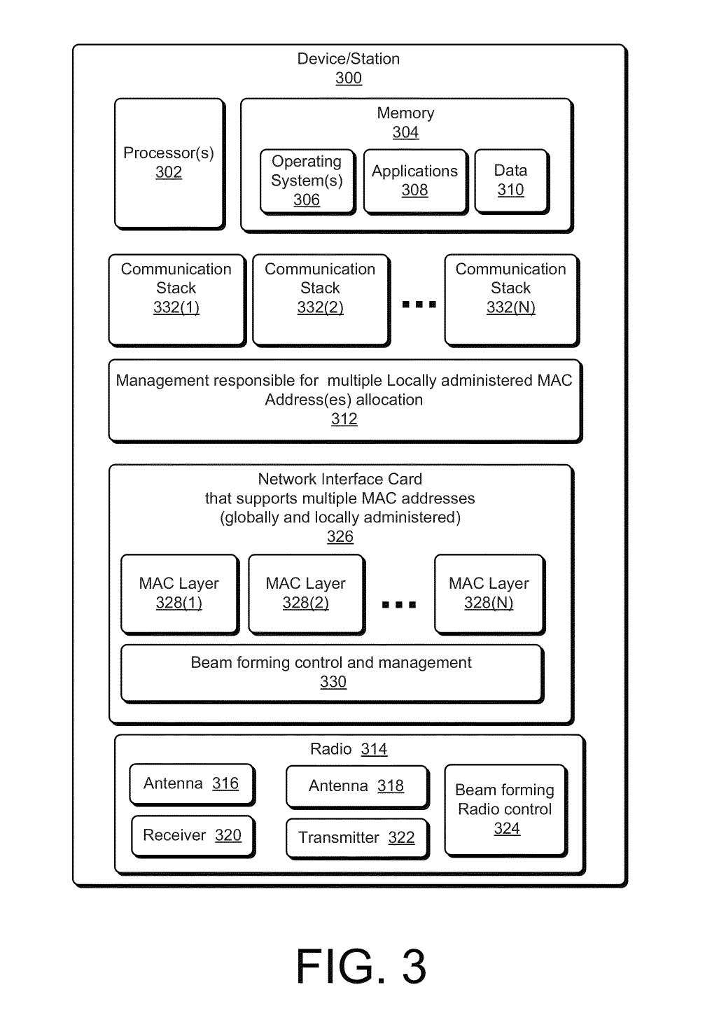

FIG. 3 shows an example device or station (STA) 300 that implements multiple media access control (MAC) addresses. Device 300 includes one or more processors, processor(s) 302. Processor(s) 302 may be a single processing unit or a number of processing units, all of which may include single or multiple computing units or multiple cores. The processor(s) 302 may be implemented as one or more microprocessors, microcomputers, microcontrollers, digital signal processors, central processing units, state machines, logic circuitries, and/or any devices that manipulate signals based on operational instructions. Among other capabilities, the processor(s) 302 may be configured to fetch and execute computer-readable instructions or processor-accessible instructions stored in a memory 304 or other computer-readable storage media.

Memory 304 is an example of computer-readable storage media for storing instructions which are executed by the processor(s) 302 to perform the various functions described above. For example, memory 304 may generally include both volatile memory and non-volatile memory (e.g., RAM, ROM, or the like). Memory 304 may be referred to as memory or computer-readable storage media herein. Memory 304 is capable of storing computer-readable, processor-executable program instructions as computer program code that may be executed by the processor(s) 302 as a particular machine configured for carrying out the operations and functions described in the implementations herein.

Memory 304 may include one or more operating system(s) 306, and may store one or more applications 308. The operating system(s) 306 may be one of various known and future operating systems implemented for personal computers, audio video devices, etc. The applications 308 may include preconfigured/installed and downloadable applications. In addition, memory 304 can include data 310. The device 300 may include a module 312 for management of multiple locally administered MAC Addresses for allocation.

The device 300 may include communication interface(s), and particularly a radio 314. Radio 314 may be coupled to two or more antennas. For example radio 314 may couple to antennas 316 and 318. Radio 314 may include at least a receiver (RX) 320, a transmitter (TX) 322 and a beam forming (BF) controller 324, although the scope of the present invention is not limited in this respect.

The device 300 may include a network interface card or NIC 326. As well known in the art, devices, such as device 300 may include various communication layers as defined by the International Organization for Standardization (ISO) Open Systems Interconnection model (OSI) model. The lowest layer (1) is the Physical layer that is called PHY and provides connection to the media. For example antennas are part of the PHY layer. The second layer is the Data. Link Layer that includes two sub layers , the MAC layer and Logical Link Control (LLC) layer. In general, NIC 326 is a physical representation of the logical layers. NIC 326 may include a global MAC address (not shown) that is unique to the device and NIC 326, and one or More MAC Layers 328. Furthermore, NIC 326 may include a beam forming control and management module 330. NIC 326 supports global and local MAC addresses. Module 312 provides for separate support of multi MAC allocation. The beam forming may receive support from PHY and MAC. In general NIC 326 supports MAC level functionality fully or partially.

Device 300 may include one or more communication stacks 332, which may be actual or virtual, to process and implement the global MAC address the locally assigned MAC addresses. In this regard, each communication stack 332 may include a MAC layer 328. The different communication stacks 332 may use different protocols, in communicating with other application devices like display, TV, mass storage, mouse, keyboard, printer, etc. or in communication with Internet specific applications like entailing, WEP browsing etc.

The example device 300 described herein is merely an example that is suitable for some implementations and is not intended to suggest any limitation as to the scope of use or functionality of the environments, architectures and frameworks that may implement the processes, components and features described herein.

Generally, any of the functions described with reference to the figures can be implemented using software, hardware (e.g., fixed logic circuitry) or a combination of these implementations. Program code may be stored in one or more computer-readable memory devices or other computer-readable storage devices. Thus, the processes and components described herein may be implemented by a computer program product.

As mentioned above, computer storage media includes volatile and non-volatile, removable and non-removable media implemented in any method or technology for storage of information, such as computer readable instructions, data structures, program modules, or other data. Computer storage media includes, but is not limited to, RAM, RUM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device.

MAC Address Data Structure

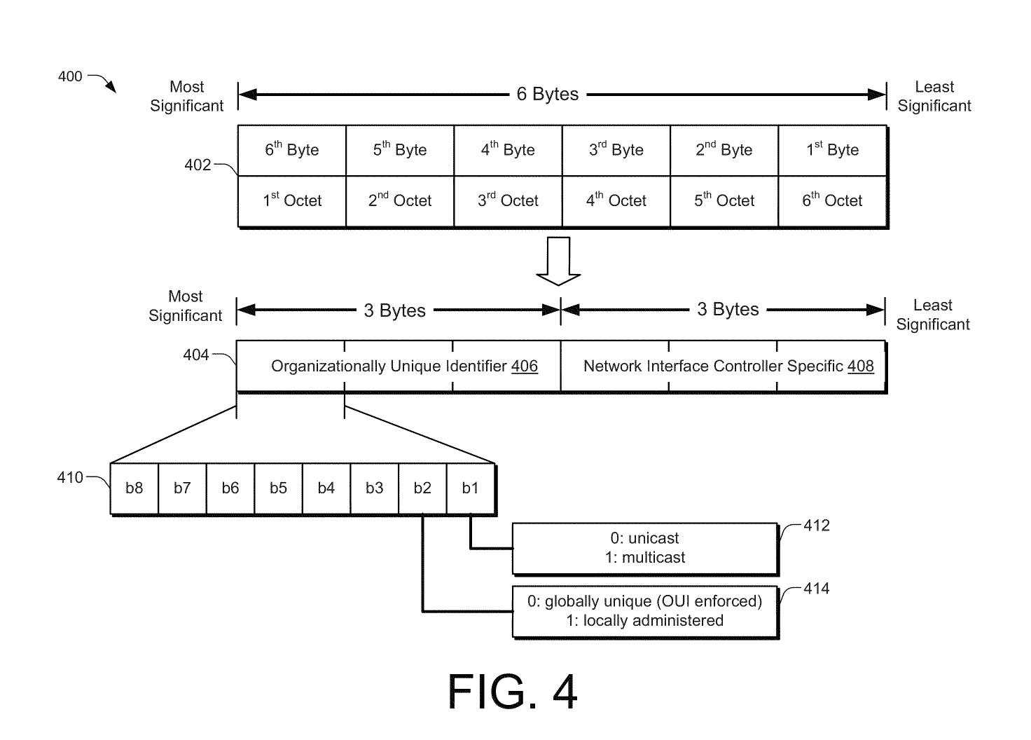

FIG. 4 shows example data structures 400 for a MAC address which can for multiple MAC addresses of a device. As discussed above, a MAC address can be a globally unique MAC address or locally defined and administered MAC address. Data structure 402 shows a MAC address with 6 bytes, represented by 6 octets, with the most significant byte at the 1st octet, and the least significant byte at the 6th Octet.

Data structure 404 further defines the 6 octets or 6 bytes of data structure 402. The three bytes of the 1st, 2nd and 3rd octets identify a unique “Organizationally Unique Identifier” or OUT 406. The OUT 406 may identify a particular vendor of the device or NIC. The three bytes of the 4th, 5th and 6th octets may be specific to a network interface card or NIC, and may be referred to as a NIC specific identifier 408.

Data structure 410 further defines that the 1st octet (which is part of the OUI identifier 406) has 8 bits “b1” to “b8”. At block 412, if the bit “B1” is set to “0” the MAC address is unicast, if set to “1” the MAC address is multicast. Block 414, defines that the if bit “b2” is set to “0” the MAC address is globally unique, and if the bit “b2” is set to “1” the MAC address is locally administered. The MAGV server 204 may generate the virtual MAC address. Therefore in an implementation, the second least significant bit of the most significant byte of the address shall be set to “locally administered” (never to match the globally unique. The OUT shall repeat the OUI of the globally unique address 406 of the STA. The 3rd byte shall repeat the 3rd byte of the globally unique address of the STA. The 1st and the 2nd bytes are used to generate the virtual addresses.

Data Structures for MAC Address Generation and Verification

As discussed above, STAs 202 may communicate through PCP 206, to access and communicate with MAGV server 204. In particular, MAGV server 204 provides and authenticates local or virtual MAC address for STAs 202. STAs 202 may request and receive such MAC addresses from MAGV server 204. PCP 206 need not know the context of the request and may be used to merely pass along the request and response between the STAs 202 and MAGV server 204.

To provide the address generation and verification service, MAC Address (MA)resolution information elements are defined to be used with known action frames like probe request and response and information request and response.

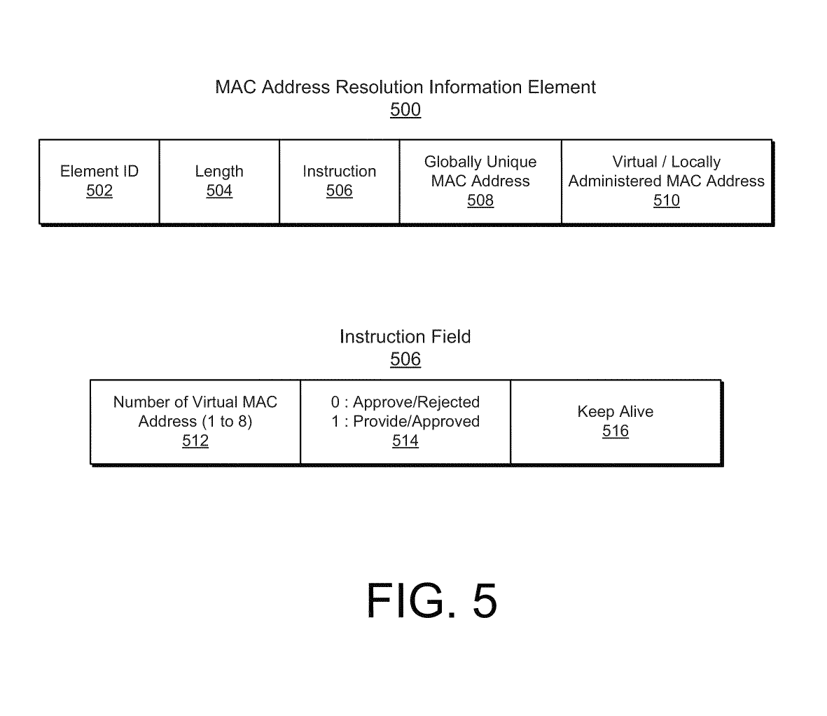

FIG. 5 shows example data structures for media access control (MAC) address generation and verification. MAC address resolution information element 500 is a data structure that includes an element ID field 502, a length field 504, an instruction filed 506, a globally unique MAC address field 508, and a virtual/locally administered MAC address field 510. Instruction field 506 may further be defined by “number of virtual MAC addresses (e.g., 1 to 8)” 512, “approve/rejected defined by ‘0’ or provided/approved defined by ‘1”’ 514, and keep alive field 516. MAC address resolution information element 500, also referred to as MAC address resolution information element 500, is used by the STA 202 to request multiple MAC addresses from the MAGV server 204, and is used by the MAGV server 204 to deliver the requested MAC addresses to the requesting STA 202.

In an example, if the MAC address resolution information element 500 is received by the MAGV server 204 and the instruction 506 is set to “0” the MAGV server 204 may verity the addresses sent in the virtual/locally administered MAC address field 510. In this case the field 510 contains the locally administered MAC addresses sent by STA 202 for verification and the MAGV server 204 may respond with field 514 set to “1” (approve) if after comparison with the data base it verifies that the addresses are locally unique. The MAGV server 204 shall respond with field 514 set to “0” (rejected) if after comparison with the data base it verifies that one or more of the addresses are not locally unique. If the instruction in the field 506 is set to “1” in the request frame the MAGV server 204 server shall provide as many virtual addresses as set in the number of virtual MAC addresses field 512. in this case there is no need to include the virtual MAC addresses fields in the MAC address resolution information element sent by the STA 202.

The MAGV server 204 may respond with the requested number of virtual MAC addresses, with field 514 set to “1” (i.e., approve) if the procedure succeeds, or “0” (i.e., rejected).

The globally unique MAC address in the field 508 may be used to generate the Locally unique MAC addresses by copying the OUI part of the address as defined in paragraph 47. The keep alive field 516 may be used to prevent the allocated addresses resetting by the MAGV server 204.

In certain implementations, the MAGV server 204 may reset a “MAC address (MA) verification timer” when the MAGV server 204 receives a MAC resolution information element identified with the globally unique address 508 of the STA and with keep alive field 516 set to “1.” It does not matter which proxy, if any, is used to deliver the MA resolution information element. In certain implementations, the MAGV server 204 resets the allocation when the MA verification timer expires.

In certain implementations, MAC address resolution information element 500 contained in the management action frames may be enveloped in Quality of Service (QoS) data frames that the MAC frame body contains an LLC header with ethertype equal to 89-0d and specific payload type that indicates enveloping of management action frame. The MAC header of the enveloped action frame may contain the receiving address (RA) that is equal to the address of the MAGV server 204. The envelope allows any device to be a proxy of the MAGV Server, for example the PCP 206 may provide the MAGV service or alternatively be PCP 206 may serve as a to deliver the management action frame to other device.

Example Process

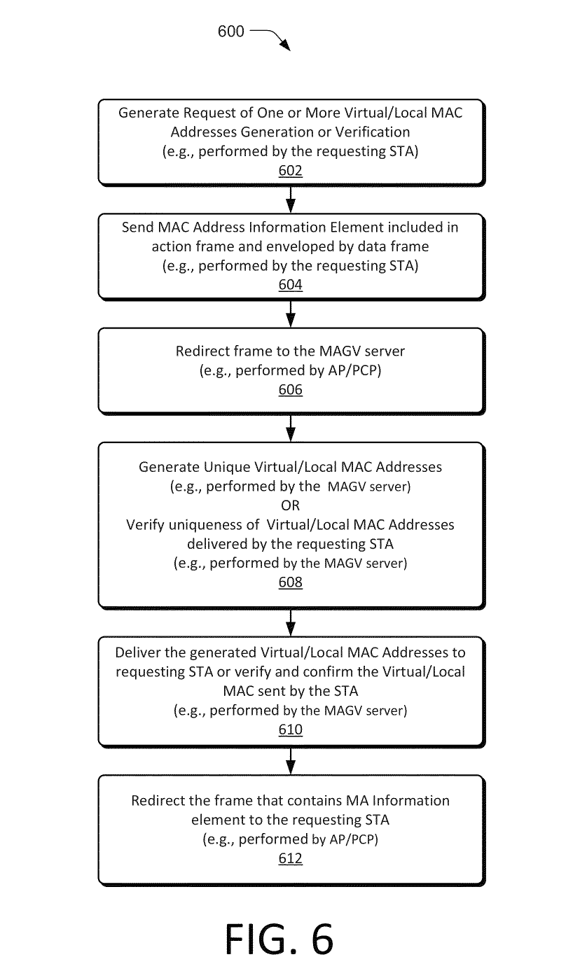

FIG. 6 shows a flow chart for an exemplary process 600 for assigning and verifying local media access control (MAC) addresses. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 602, request is generated or verification is performed. For example, a STA or device may request the MAGI server 204 to generate one or more virtual/local MAC addresses or to verify one or more addresses generated by the STA or device itself. In the latter case the STA or device includes the generated addresses in the MA Information element for verification. As discussed above, the request may be made by one or more devices or STAs in a network, connected to an AP or PCP. The AP or PCP may forward the requests to a MAC address generation and verification server.

At block 604, a device or STA, sends an action frame with MAC address resolution information element that contains unique global MAC address, where the global MAC address is particular to the device or STA. Likewise, the action frame may be sent through an AP/PCP as discussed. Furthermore, as discussed above, the request of 602 and sending of 604, may be in the form of a MAC address information element that is included in an existing or known action frame. For example, the action frame is enveloped in the QoS Data frame. The QoS data frame contains the LLC header with ethertype equal to 89-0d and the specified payload type.

At block 606, a redirection may be performed. in particular, a frame (i.e., action frame) is redirected to the MAGV server, and may be performed by an AP or PCP.

At block 608, the unique virtual/local MAC addresses may be generated or verified. The generating may be performed by and at the MAC address generation and verification server. The generated virtual/local MAC addresses may be specific to a network that the requesting device or STA resides. The verifying of the uniqueness of the virtual/local MAC addresses as delivered by the requesting device(s) or STA may be performed by the MAGV server.

At block 610, the virtual/local MAC addresses are delivered to requesting devices or STAs. Furthermore confirmation may be made as to the virtual/local MAC addresses sent by devices or STAs. This may be performed by the MAGV server.

At block 612, redirection may be performed as to an action frame that includes the MAC information element to the requesting STA. The redirection may be performed by an AP or PCP.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A device comprising:
one or more processors;
memory configured to the one or more processors;
and
multiple media access control (MAC) addresses stored on the memory, wherein the MAC addresses are generated and verified by an external entity.

2. The device of claim 1 wherein the device implements a MAC address resolution information element to request MAC addresses.

3. The device of claim 2 wherein the MAC address resolution information element includes a global unique MAC address and one or more virtual local MAC addresses.

4. The device of claim 2 wherein the MAC address resolution information element includes virtual local MAC addresses requested from the external entity.

5. The device of claim 1 wherein the external entity is a MAC address generation and verification (MAGV) server.

6. The device of claim 5 wherein the MAGV server is an access point or in PBSS control point (PCP).

7. The device of claim l further comprising a radio through which requests and verification of MAC addresses are sent and received to the external entity.

8. The device of claim 7 wherein the radio communicates to the external entity through an access point or PBSS control point (PCP).

9. The device of claim 7 wherein the radio operates in the DBand.

10. The device of claim 7 wherein the radio provides beam formed links.

11. The device of claim 10 wherein tunneling is provided.

12. A system comprising:
one or more stations (STA), wherein each STA includes a globally unique media access control address (MAC);
an personal basic service set (PBSS) control point or PCP that connects with the STAs; and
a server that connects with the PCP, receives the globally unique MAC address, and generates and verifies local MAC addresses for the STAs.

13. The system of claim 12 wherein the STAs provide beam formed links to the access point and/or the server.

14. The system of claim 13 wherein tunneling is provided in the beam formed links.

15. The system of claim 12 wherein the STAs communicate through action frames to request and verify the local MAC addresses, wherein the action frames include MAC address resolution information element.

17. The system of claim 12 wherein communication between the STAs and PCP is in the mm Wave band.

17. The system of claim 12 wherein communication between the STAs and access point is in the Dband.

18. A method for assigning and verifying local media access control (MAC) addresses comprising:
requesting one or more local MAC addresses by delivering a MAC address resolution information element that contains a global unique MAC address;
tunneling the request through a proxy to a MAC addresses generation server;
responding with the requested or verified MAC addresses;
tunneling the response through the proxy; and
receiving generated or verified local virtual MAC addresses.

19. The method of claim 18 wherein the MAC address resolution information element is included in an action frame.

20. The method of claim 18 wherein the proxy is an access point or PBSS control point.
